(19) United States
(12) Patent Application Publication
(10) Pub. No.: US 2018/0036745 A1
(43) Pub. Date: Feb. 8, 2018

(54) DRIVE ARRANGEMENT

(71) Applicant: HANNING ELEKTRO-WERKE GmbH & Co. KG, Oerlinghausen (DE)

(72) Inventor: Harald Buchalla, Soest (DE)

(21) Appl. No.: 15/551,908

(22) PCT Filed: Feb. 18, 2016
(86) PCT No.: PCT/DE2016/100074

§ 371 Date: Oct. 17, 2017

(30) Foreign Application Priority Data
Feb. 20, 2015 (DE) 10 2015 102 476.4

(51) Int. Cl. B04B 9/04; B04B 9/14; H02K 7/09; H02K 5/24; H02K 7/08; B04B 9/12; H02K 11/21

(52) U.S. Cl. CPC B04B 9/04; B04B 9/12; B04B 9/146; H02K 11/21; H02K 5/24; H02K 7/083; H02K 7/09; F16C 19/527

(57) ABSTRACT

A drive arrangement for a rotational body device comprising a shaft which is held rotatably with respect to a rotational axis, a first bearing module and a second bearing module, each with at least one elastic support element for supporting the shaft, an electric motor, an electrically actuable stabilisation device, and a housing. At least the first bearing module provides a mass body which is held in a non-rotatable fashion with respect to rotational axis by means of the at least one elastic support element. The shaft is supported in a rotatable fashion on the mass body by a bearing of the first bearing module.

The invention relates to a drive arrangement for a rotational body device comprising a shaft mounted rotatably with respect to a rotation axis, a first bearing module and a second bearing module, each with at least one elastic support element for supporting the shaft, an electric motor having a stator and a rotor which rotor is provided so as to be rotatable with respect to the stator and is connected in a rotationally fixed manner to the shaft, an electrically actuable stabilizing device which acts on the rotor in such a way that interfering forces acting upon the shaft and the rotor during rotation are counteracted, a housing which at least partially surrounds the stator and a sensor unit for detecting a tilt of the shaft relative to the stator.

From DE 10 2009 009 961 B4 a generic drive assembly is known which is used, for example, in laboratory centrifuges for stabilizing and to reduce oscillations. Here, an elastic or soft mounted shaft is provided, on the end of which is mounted a rotation body, and which is driven by an electric motor. For the elastic mounting of the shaft, it is provided, for example, that the ball bearings supporting the shaft are held in the region of an outer ring of the ball bearings via elastic support elements, for example elastomer rings, so that the shaft bearing as a whole becomes soft. The electric motor is provided with a stabilization unit, having magnetic support members assigned to the stator of the electric motor. The magnetic support members comprise current-carrying windings which are electrically controllable and reduce an imbalance as a result of a disturbing force acting on the rotor during operation by providing radial compensating or balancing forces. The magnitude of disturbance forces is identified thereby, in that disturbance forces causing interference are detected by sensors, and via the stabilization device a disturbance compensating signal corresponding to the sensor-detected interference influence is determined and is transmitted to the windings of the magnetic support members. Overall, it is possible to optimize the run-up of the rotational body device and in particular to reduce the tendency to oscillate the same in the proximity of a resonant frequency.

It is thus the object of the present invention, starting from the above-described arrangements, to improve a drive arrangement for a rotational body means so that a stable and energetically advantageous operation is achieved at an operating speed above the resonant speed.

To solve the problem the invention is characterized, in connection with the preamble of claim 1, in that at least the first bearing module provides a mass body which is held in a non-rotatable fashion with respect to rotational axis by means of the at least one elastic support element, and in that the shaft is supported in a rotatable fashion on the mass body by means of a bearing of the first bearing module.

The particular advantage of the invention is that, by providing the additional mass body, the rotational body device with the inventive drive assembly can be operated permanently with energy efficiency in a nominal operating point. The drive arrangement according to the invention at the same time favors stability, since the mass body, which is held non-rotatingly on the at least one elastic support element, reduces the oscillation tendency of the rotational body device. Here, in particular, the weight of the mass body has a vibration-reducing effect, with the consequence that the stabilization device needs to be actively promoting stability only over a reduced amplitude of the rotating system. That is, a reduction in the interference effects is achieved passively by the provision of the mass body, which is embodied as part of the first bearing module. In this case, the mass body is provided as a mass body secured non-rotatingly via the at least one elastic support element. The rotating shaft, in turn, is supported on the mass body via a bearing of the first bearing module. The elastic support element carrying the mass body can at the same time provide an elastic, soft mounting for the shaft. An additional elastic body mounted, for example, between the shaft supporting bearing and the mass bodies, can be omitted.

It is the essence of the invention, that by the provision of the elastically supported rotationally constrained mass body, to positively influence in a passive manner the tendency of the drive assembly to vibration at the nominal operating point, and to utilize the measures for active vibration damping during the run-up or acceleration process up to the rated speed at the nominal operating point. In this respect, the energy consumption for the operation of the stabilization device is reduced and the vibration amplitude in the nominal operating point is reduced. The rotational body device with the drive arrangement according to the invention can therefore be operated with low energy levels above the first resonant frequency, in particular at high rotational speeds in the rotational speed range. The stabilizing device serves, on the one hand, to counteract the oscillation tendency of the drive arrangement during start-up. Secondly, the disturbances which occur at the nominal operating point, for example, due to an imbalance, despite the provision of the mass body, are counteracted by countervailing forces. The intensity or frequency of the active intervention is much less intense, or less than that of the drive arrangement in use today.

Investigations by the applicant have shown that an elastically supported mass body which does not rotate with the shaft contributes in a particularly advantageous manner to a reduction in the tendency of the drive arrangement or of the rotational body device to vibrate. The lower the vertical distance of a center of gravity of the mass body from an effective center of the bearing assigned to the first bearing module, the more favorable the operating characteristics. For example, the distance of the center of gravity of the mass body from the active center plane of the first bearing is preferably smaller than an effective bearing diameter of the first bearing. Preferably, the distance of the center of gravity of the mass body from the active-center plane of the first bearing is less than half the effective bearing diameter of the first bearing. Particularly preferably, the distance of the center of gravity of the mass body from the effective center of the bearing is less than a thirtieth of the effective bearing diameter of the first bearing. In the best case, the center of gravity of the mass body is in the active center plane of the first bearing. Constructively, the vertical distance may be set smaller than 10 mm and preferably be less than 1 mm. The effective center plane of the bearing is defined as the plane, in which the bearing support forces imparted by the bearing occur in a standard bearing model. The active center plane may coincide with a geometrical center plane of the bearing or be determined by the position of the rolling elements or the roller body contact points of a rolling bearing. The effective bearing diameter is determined by a functional center of action of the bearing relative to the relative movement of the bearing components. In the case of roller bearings, the effective bearing diameter is determined, for example, at a geometrical center or a center axis of the rolling elements. With a sliding bearing, an annular or a cylindrical interface is placed between the relatively moving sliding surfaces.

According to a further development of the invention, the center of gravity of the mass body, with reference to a rest position of the drive assembly, lies on the rotational axis of the shaft. The rest position of the drive arrangement is defined as the position in which the shaft, with the rotor held non-rotatably thereon, is oriented coaxially with the axis of rotation. In the rest position, the shaft neither displaced parallel to the axis of rotation, nor is it pivoted about a tilt axis oriented perpendicular to the axis of rotation. An air gap is formed uniformly in the circumferential direction between the stator and the rotor of the electric motor, disregarding manufacturing or assembly introduced tolerances.

According to a further development of the invention, the bearing associated with the first bearing module is provided in a recess of the mass body. Advantageously, the provision of the bearing in the recess of the mass body results in a particularly compact, space-saving construction of the drive arrangement. At the same time, the symmetry of the drive arrangement is favored and thus the tendency to vibration is constructively reduced. For example, the mass body is formed rotationally symmetrical, wherein the bearing associated with the first bearing module is provided in the axis of symmetry located coaxial with the rotational axis of the drive arrangement in the resting state. For example, the mass body has a continuous and preferably a concentric mass distribution with respect to the axis of rotation in the rest position. The symmetry axis of the mass body is arranged preferably oriented coincident to the rotational axis of the shaft, that is, neither displaced parallel to the rotation axis nor tilted with respect thereto.

According to a further development of the invention, the weight of the mass body corresponds to at least 10% of a weight of the rotating components of the rotating body means. Preferably, the weight of the mass body corresponds to at least 20% of the weight of the rotating components of the rotating body means. Advantageously, the vibration tendency of the drive arrangement or of the rotational body device is particularly effectively suppressed at these weight ratios. The rotating components include, besides the shaft, the rotor of the electric motor, as well as a rotational body of the rotational body device fixed on an end of the shaft, in which, for example in the case of a laboratory centrifuge, samples can be placed.

According to a further development of the invention, a first position sensor of the sensor unit is provided adjacent to the first bearing module and a second position sensor is provided adjacent to the second bearing module. In particular, distance sensors or speed sensors or acceleration sensors are provided as first and second position sensors, respectively. For example, the rotor and the position sensors are provided between the bearing modules. In particular, the position sensors are assigned to opposite ends of the rotor. The sensors interact with the sensor unit in such a way that a displacement of the shaft perpendicular to the axis of rotation is detected from the sensor signals on the side of the sensor unit, or a pivoting about the tilting axis is determined in tennis of magnitude and/or direction. By providing position sensors spaced from one another in the direction of the rotational axis, the position of the shaft during operation can be precisely determined by means of a differential or comparative measurement. With knowledge of the position of the shaft, based on the signals from the position sensors, restorative signals may be generated by the stabilization device, which serve to impart compensatory forces on the stator and a stabilizing effect influencing the rotating system comprising shaft and rotor. For example the stabilizing device comprises magnetic support members distributed circumferentially about the rotation axis and supporting the stator. The magnetic support members are formed for example as current-conducting windings individually controllable such that radial balancing forces are produced counteracting the disturbing forces. The compensatory force is adjusted in terms of amount and direction to balance the interfering forces occurring during operation.

In order to limit the displacement of the elastically supported mass body associated with the first bearing module, abutments or stops for the mass body can be provided. By means of the stops, a maximum displacement path for the mass body is limited such that it is smaller than the air gap formed in the electric motor between the stator and the rotor. Advantageously, damage to the drive arrangement during operation is reliably counteracted even in the case of large unbalanced forces.

Further advantages, features and details of the invention can be taken from the further subclaims and the following description. Characteristics mentioned there can relevant to the invention either individually or in any desired combination. The drawings are merely illustrative of the for clarification of the invention and are not limiting.

There is shown in:

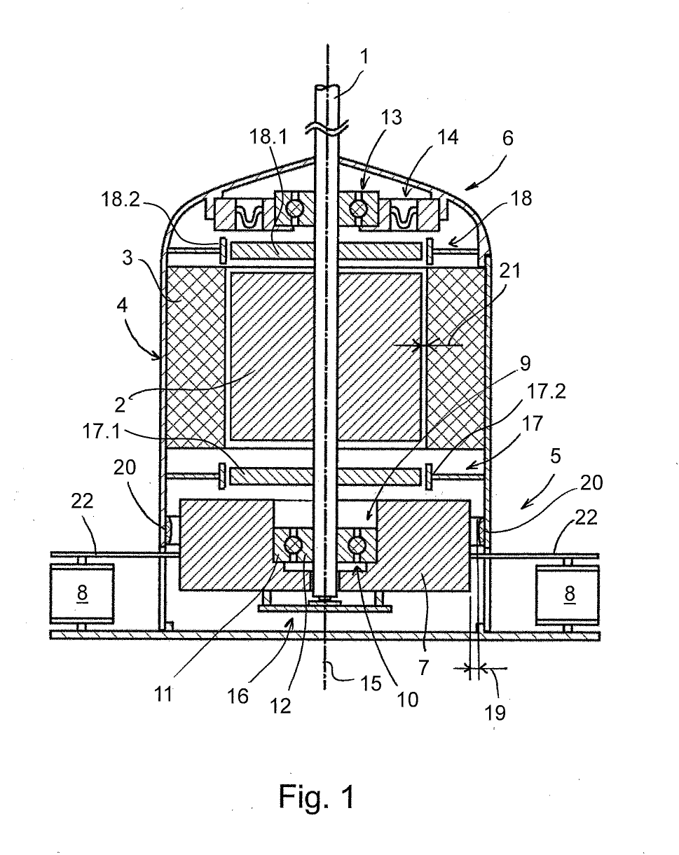

FIG. 1 a schematic diagram of a drive arrangement of the invention for a rotational body device having a resiliently supported shaft and a mass body according to the section AA,

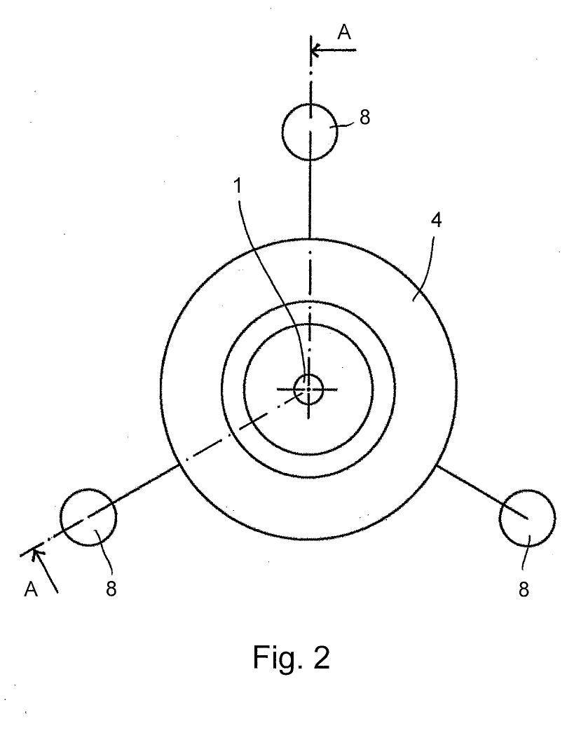

FIG. 2 a plan view of the drive arrangement according to FIG. 1,

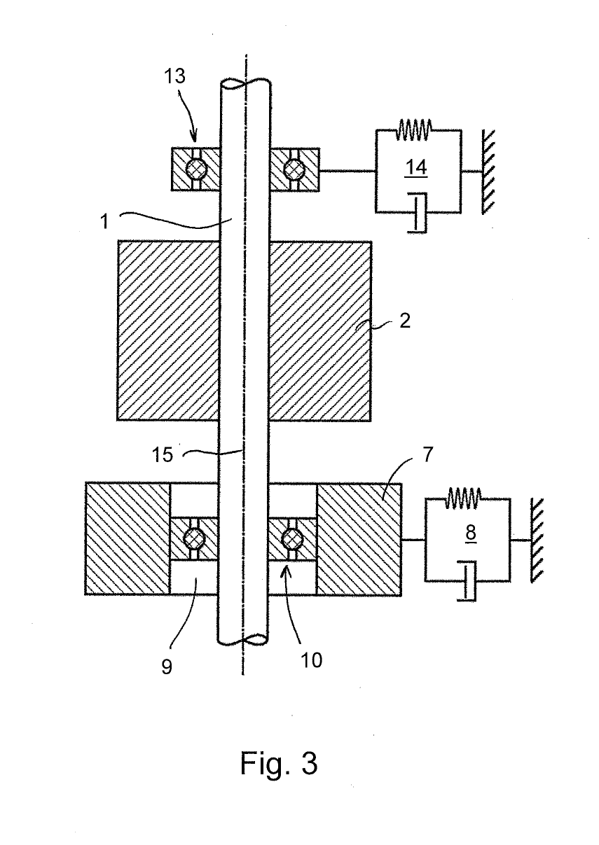

FIG. 3 a visualization of the physical operating principle of the drive arrangement according to the invention,

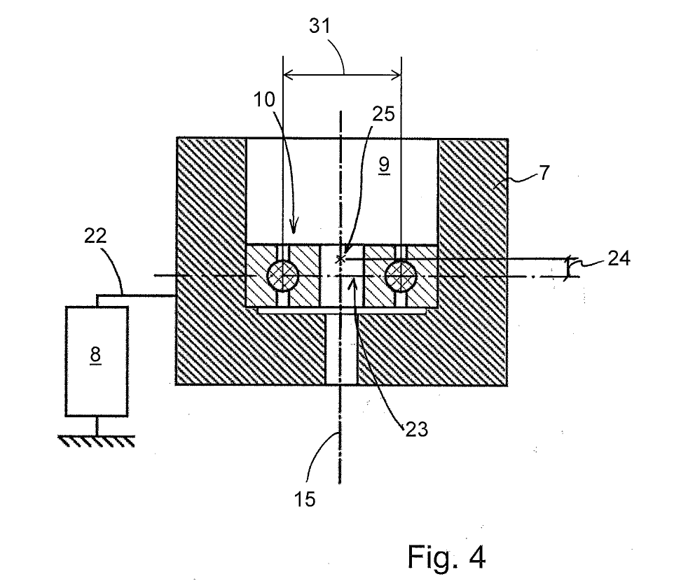

FIG. 4 an arrangement of a bearing of the drive arrangement to the elastically held mass body,

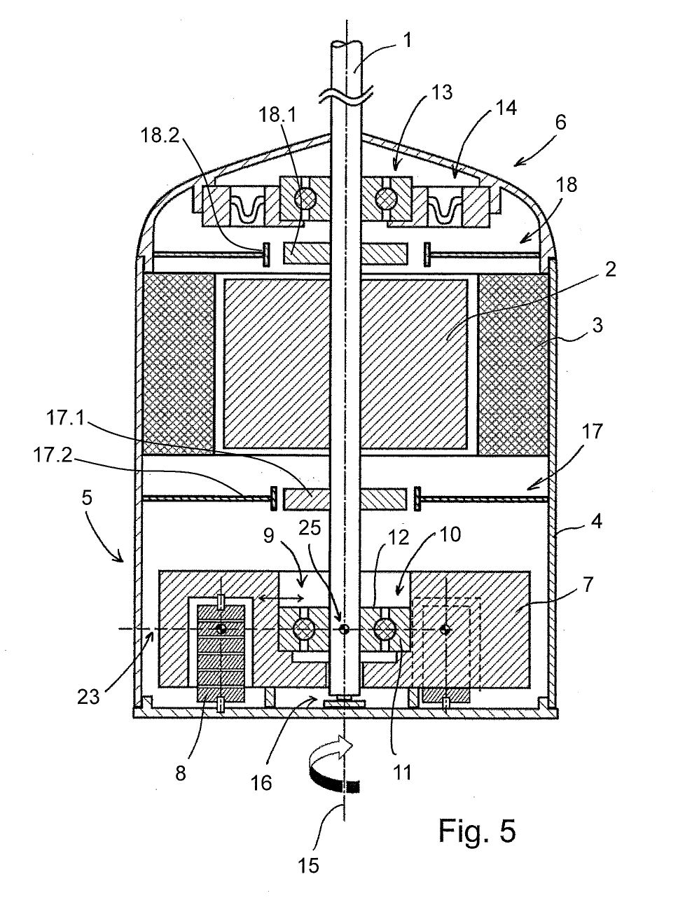

FIG. 5 a second embodiment of the drive arrangement of the invention in a sectional illustration,

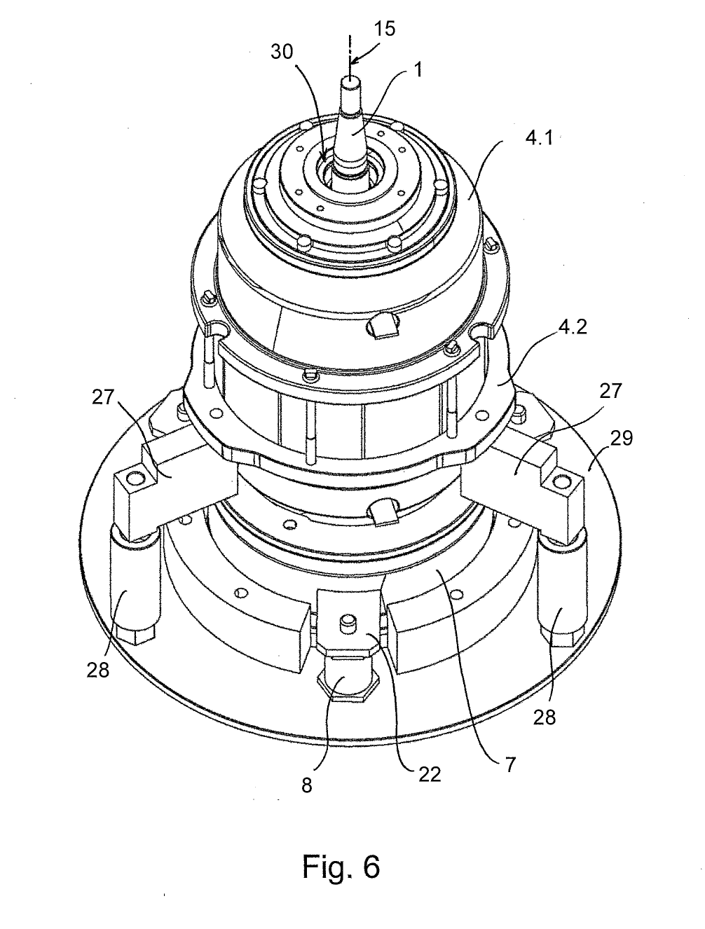

FIG. 6 a perspective view of a third embodiment of the drive arrangement according to the invention, and

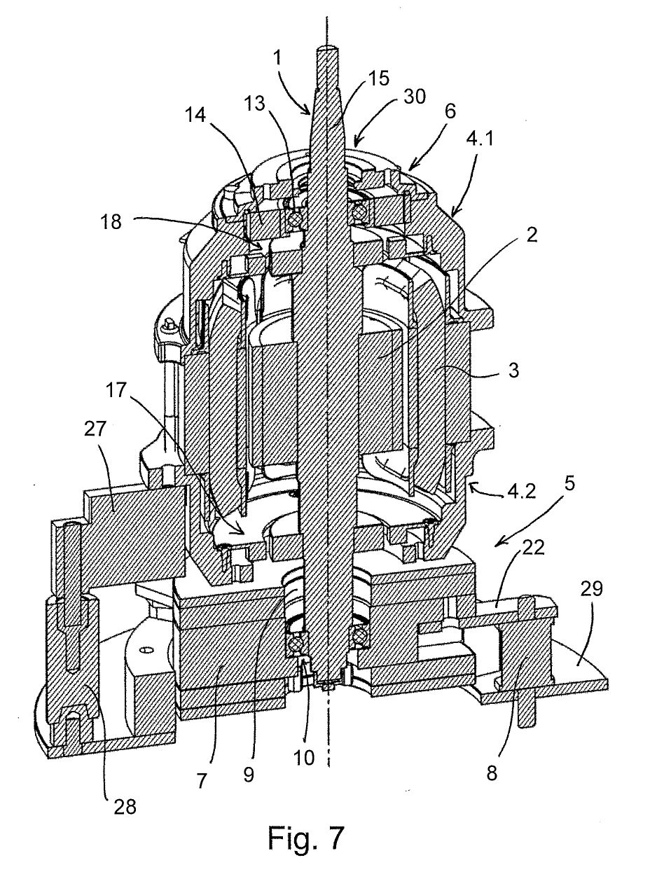

FIG. 7 a sectional view of the drive arrangement according to FIG. 6.

A drive assembly according to the invention according to FIGS. 1 and 2 comprises, in the illustrated rest position, a substantially vertically oriented shaft 1, an electric motor with a rotor 2 fixed rotationally on the shaft 1, a stator 3 surrounding the rotor 2, which is set in a bell-shaped housing 4, as well as a first bearing module 5 and a second bearing module 6 for supporting the shaft 1. The first bearing module 5 provides a mass body 7, which surrounds the shaft 1 on the housing side, and three resilient support elements 8 distributed circumferentially disposed non-rotatable with respect to the shaft 1. A recess 9 is formed in the mass body 7 which serves to receive a bearing 10 assigned to the first bearing module 5. The bearing 10 is formed by way of example in the manner of a ball bearing, a stationary outer ring 11 of the bearing 10 being supported on the mass body 7 and the bearing 10 being connected to the shaft 1 by an inner ring 12. In the region of the first bearing module 5, the shaft 1 is resiliently mounted. In this case, the elasticity is provided by the elastic support elements 8. Similarly, in the area of the second bearing module 6 the shaft 1 is elastically supported by a bearing 13 assigned to the second bearing module 6. The bearing 13 is likewise designed in the manner of a ball bearing and is supported in the housing 4 via an elastomer ring 14.

The shaft 1, resiliently supported by the bearing modules 5, 6, is rotatably supported with respect to a rotation axis 15. At the free end of the rotation axis 15 opposite the first bearing module 5, which extends out from the housing 4, a rotating body, for example a sample-receiving body, is mounted fixed against rotation. The drive assembly according to the invention is particularly part of a rotational body means which is designed for example in the manner of a laboratory centrifuge.

As part of the drive arrangement, there is provided a not fully illustrated sensor device and a likewise not illustrated stabilization device. The stabilization device includes a plurality of magnetic support members arranged circumferentially distributed about the rotation axis 15, associated with the stator 3, which have current-carrying windings and are so individually controllable electrically, that disturbing forces that occur during operation of the drive assembly are counteracted from the stabilization device by balancing forces acting radially via the magnetic support members. With the aid of the stabilizing device, interfering influences occurring during operation can be reduced and the vibration tendency of the drive arrangement can be counteracted. The stabilization device receives measurement or, as the case may be, control signals of a sensor unit. The sensor unit is used to detect a rotation of the shaft 1 about the axis of rotation 15 and additionally a tilt of the shaft 1 about a tilt axis oriented perpendicular to the axis of rotation 15 or as the case may be a parallel displacement of the shaft 1 perpendicular to the rotation axis of 15. For this purpose, the position of the shaft 1 is determined via a speed sensor 16, a first position sensor 17 and a second position sensor 18. The first position sensor 17 which is provided between the first bearing module 5 and the electric motor cooperates with the second position sensor 18 which is provided between the electric motor and the second bearing module 6, for example by means of an absolute measuring arrangement so that a displacement of the shaft 1 perpendicular to the axis of rotation 15 or a pivoting of the shaft 1 about a tilting axis oriented perpendicular to the axis of rotation 15 is determined in terms of magnitude and/or direction. The first position sensor 17 and the second position sensor 18 are formed, for example, in the manner of a displacement, velocity or acceleration sensor. Each of the position sensors 17, 18 has an encoder disc 17.1, 18.1 rotationally fixed connected to the shaft and detectors 17.2. 18.2 associated with the transmitter discs 17.1, 18.1. The detectors 17.2, 18.2 are provided for example distributed in the circumferential direction about the encoder disk of 17.1, 18.1 or are ring shaped. By way of example four detectors 17.2, 18.2 are provided in the illustrated example, which are provided in a measuring plane extending perpendicular to the rotational axis 15 at an angle of 90° to each other. For example, a measurement with only two mutually angularly displaced associated detectors 17.2, 18.2 take place. The detectors are, for example, offset by 90° relative to one another in the measuring plane. The speed sensor 16 is associated with the shaft 1 in the region of the first bearing module 5. It includes, for example, a Hall sensor, which is adapted to detect the rotation speed, the rotation angle or the rotation direction of the shaft 1, and which interacts with an encoder associated with the Hall sensor. For example, the Hall sensor is associated with the shaft in the area of the first bearing module 5 and the incremental encoder is mounted on the mass body 7. Since the mass body 7 is supported on the shaft 1 in a play-free and rotatable manner via the bearing 10, there results an exact positional arrangement of the functional components of the rotational speed sensor 16 when the drive arrangement is excited to oscillation during operation.

Due to the provision of the circumferentially arranged distributed elastic support elements 8 in the area of the first bearing module 5 and the elastomer ring 14 in the area of the second bearing module 6, the shaft 1 is supported resiliently and mounted displaceably in relation to the rest position of the drive assembly axis of rotation 15. The bearing modules 5, 6 enable in this way a “soft” or yielding support of the shaft 1. Due to the soft support of the shaft 1 in cooperation with the stabilizing means, the vibration behavior of the drive assembly, in particular during the run-up in the range of a resonant frequency or during continuous operation at the nominal operating speed, are positively influenced.

In operation, interfering influences will arise, for example, due to an asymmetrical distribution of mass of the rotating body, which will be counteracted, in particular during the run-up operation to the rated speed, by an active intervention by the stabilizing device. Insofar, in particular in the region of the resonance rotating speed, the interference influences or forces are detected by sensors and balancing forces are imparted on the rotor 2 by the magnetic support members, which dampen the vibration of the shaft 1 with the thereon mounted rotor 2 and limit the amplitude of the oscillations. At the nominal operating point, an active vibration damping by means of the stabilization device is also conceivable in principle. However, due to the high rotational speed, the power requirement for the operation of the stabilizing device is very high. For this reason, the tendency to vibration of the drive assembly, particular in the region of the nominal speed, is passively reduced in the soft-supported shaft 1 by the provision of the mass body 7. For this purpose, the mass body 7 is held non-rotatably relative to the elastic support elements 8. The shaft 1, which is rotatably supported relative to the mass body 7 via the bearing 10 assigned to the first bearing module 5, can be vibrated or displaced together with the mass body 7 in a vibration oscillation oriented perpendicular to the axis of rotation 15. A maximum displacement 19 for the mass body 7 and the shaft 1 is in this case defined by stops 20 provided on the housing 4. The maximum displacement path 19 is thereby smaller than an air gap 21 formed in the electric motor between the rotor 2 and the stator 3.

The elastic support elements 8 are formed, for example, from an elastomer material. The support elements 8 can in particular be made of elastomeric solid material or be formed by layers of elastomer and non-elastomer annular disks which are connected to one another. The non-elastomer annular disks can, for example, be made of a metallic material. The support elements 8 can be realized, for example, in the form of cuboids or cylindrically. In the illustrative case, the resilient support elements 8 are mounted outside the housing 4. The elastic support elements 8 support the mass body 7 via substantially horizontally extending arms 22.

By selecting the composition of the support elements 8, a specific bearing can be formed with a desired bearing stiffness or a desired attenuation. For example, the bearing can be radially soft and axially hard relative to the axis of rotation 15.

The elastomer ring 14 of the second bearing module 5 can be made, for example, from a solid elastomer material. For example, the geometry of the elastomer ring 14 may be chosen such that for the second bearing module 6, a defined stiffness, or a predetermined amount of attenuation, is set. The elastomer ring 14 can, for example, be implemented in a meandering shape.

The basic idea of the invention is illustrated in the schematic diagram of FIG. 3. It is essential that the elastically mounted mass body 7 is held fixed against rotation with respect to the shaft 1 by the resilient support elements 8. The shaft 1 is supported on the mass body 7 by means of the bearing 10 assigned to the first bearing module 5. In the region of the second bearing module 6, the provision of a mass body 7 is dispensed with. The bearing 13, which is assigned to the second bearing module 6, is directly held resiliently via the elastomer ring 14. In this case, the mass body 7 is not realized as a rotating mass body 7, but rather is held yieldingly by the elastic support elements 8.

FIG. 4 shows an example of the dimensioning of the mass body 7 and the relationship thereof to the bearing 10 of the first bearing module 5. The bearing 10 defines by its geometry an effective center plane 23. A vertical distance 24 to a center of gravity 25 is shown exaggerated only for illustrative clarity. The vertical distance 24 is in accordance with the invention smaller than an effective bearing diameter 31 of the bearing 10. Preferably, the distance 24 from the center of gravity 25 of the mass body 7 to the effective center plane 23 of the bearing 10 is smaller than half the effective bearing diameter 31 of the bearing 10. It is particularly preferred that the distance 24 from the center of gravity 25 of the mass body 7 of the effective center plane 23 of the bearing 10 is less than one-thirtieth of the effective bearing diameter 31 of the bearing 10. For example, the vertical distance 23 [sic] is less than 10 mm and preferably less than 1 mm. More preferably, the center of gravity 25 is located in the effective center plane 23 of the bearing 10 associated with the first bearing module 5.

In the present case, the effective bearing diameter 31 is determined by the distance between the centers of the balls of the ball bearing. Depending on the bearing construction, the effective bearing diameter 31 can, for example, stop at a center axis distance of the rolling elements of a roller, barrel or needle bearing or as the case may be a diameter of a plain bearing bush.

FIG. 5 shows an alternative embodiment of the drive arrangement according to the invention, which is designed differently in particular in the region of the first bearing module 5. As before the mass body 7 surrounds the shaft 1 and defines an opening recess 9 provided for receiving the bearing 10. The resilient support elements 8 are arranged circumferentially distributed in relation to the rotational shaft 15 inserted in pocket-shaped recesses 26 of the mass body 7, so that a particularly slim construction and the arms 22 projecting relative to the housing 4 are dispensed with. The center of gravity 25 of the mass body 7 lies in the effective center plane 23 of the bearing 10.

The same components and component features are designated by like reference numerals.

According to a third exemplary embodiment of the invention according to FIGS. 6 and 7, the electric motor is designed housing-less. The stator 3 is fixed between two housing segments 4.1, 4.2 interconnected by tie rods. The housing segments 4.1, 4.2 are supported by means of three circumferentially evenly arranged cantilever arms 27, and elastomer bodies 28 associated with the cantilever arms 27, on a base plate 29 of the drive arrangement. Likewise, the mass body 7 is fixed to the base plate 29 via the arms 22 and the elastic support elements 8. The shaft 1, which extends out of the first housing segment 4.1 via an end-face opening 30, is designed to receive a rotational body (not shown). The rotational body has on an underside facing the drive assembly, for example, a bell-shaped recess which is adapted to the bell shape of the drive assembly and into which in any case the drive assembly protrudes in sections.

For example, the drive arrangement is supported by the cantilever arms 27 on a stationary support element, for example a laboratory table. The support of the drive arrangement in the region of the cantilever arms 27 then results in that the mass body 7 is provided suspended, in relation to the electric motor or the stator 3, via the elastomer bodies 28, the base plate 29 and the support members 8 is. For example, a recess in the laboratory table can be provided for fixing the drive arrangement, which is determined with regard to its geometry in such a way that the drive arrangement is inserted into the recess and the first bearing module 5 with the mass body 7 is arranged below a workbench defined by the laboratory table.

1. A drive arrangement for a rotational body device including
a shaft (1) provided rotatable with respect to a rotational axis (15),
a first bearing module (5) and a second bearing module (6) each having at least one resilient support member (8) for supporting the shaft,
an electric motor with a stator (3) and a rotor (2) which is provided so as to be rotatable relative to the stator (3) and is connected rotationally fixedly to the shaft (1),
an electrically controllable stabilizing means, which acts on the rotor (2) in such a manner, that interference forces acting on the shaft (1) and the rotor (2) during rotation are counteracted,
a housing (4) at least partially encompassing the stator (3) and
a sensor unit for detecting a rotation or twist of the shaft (1) relative to the stator (3), wherein at least the first bearing module (5) is provided with a mass body (7) held non-rotatable with respect to the rotation axis (15) by means of the at least one elastic support element (8) and wherein the shaft (1) is rotatably supported on the mass body (7) via a bearing (10) of the first bearing module (5).

2. The drive arrangement according to claim 1, wherein a vertical measured distance (24) from a center of gravity (25) of the mass body (7) to an effective center plane (23) of the bearing (10) associated with the first bearing module (5) is smaller than an effective bearing diameter (31) of the bearing (10) associated with the first bearing module (5).

3. The drive arrangement according to claim 1, wherein the bearing (10) associated with the first bearing module (5) is provided in a recess of the mass body (7).

4. The drive arrangement according to claim 1, wherein a weight of the mass body (7) corresponds to at least 10% of a weight of the rotating components of the rotational body device.

5. The drive arrangement according to claim 1, wherein at least three support elements (8) are provided arranged circumferentially distributed.

6. The drive arrangement according to claim 1, wherein the sensor unit is adapted for detecting a tilt of the shaft (1) around the axis of rotation (15) and at least one tilt axis oriented perpendicular to the rotational axis (15).

7. The drive arrangement according to claim 1, wherein the sensor unit comprises a speed sensor (16) and/or a rotational angle transmitter and/or a position sensor (17, 18) for the shaft (1).

8. The drive arrangement according to claim 1, wherein a first position sensor (17) of the sensor unit is provided adjacent to the first bearing module (5) and a second position sensor (18) for the shaft (1) is provided adjacent to the second bearing module (6).

9. The drive arrangement according to claim 8, wherein the first position sensor (17) and the second position sensor (18) in each case provides at least one displacement and/or speed and/or acceleration sensor and so cooperates with the sensor unit that a displacement of the shaft (1) perpendicular to the axis of rotation (15) is detected by means of the position transmitters (17, 18) and/or deviation from the tilt axis in terms of magnitude and/or directionally is determined.

10. The drive arrangement according to claim 1, wherein stops (20) are provided for limiting a displacement of the elastically mounted mass body (7) associated with the first bearing module (5), and/or wherein a maximum displacement path (19) for the mass body (7) is smaller than the air gap (21) formed in the electric motor between the stator (3) and the rotor (2).

11. The drive arrangement according to claim 1, wherein the rotor (2) of the electric motor held fixed against rotation on the shaft (1) and the at least one position sensor (17, 18) of the sensor unit associated with the shaft (1) are provided between the two bearing modules (5, 6) and/or wherein the position sensors (17, 18) are on surfaces opposite the rotor (2).

12. The drive arrangement according to claim 1, wherein the first bearing module (5) and/or the second bearing module (6) provide a roller bearing and/or a slide bearing for supporting the shaft (1).

13. The drive arrangement according to claim 1, wherein an elastomer ring (14) is provided as the elastic support element for the first bearing module (5) and/or for the second bearing module (6).

14. The drive arrangement according to claim 1, wherein the stabilizing means includes magnetic support members arranged circumferentially distributed about the axis of rotation (15), and wherein the magnetic support members are constructed as current-carrying windings and individually are electrically controllable such that a radial balancing force counteracting disturbing forces is produced.

15. The use of a drive arrangement according to claim 1 in a laboratory centrifuge, wherein a sample receiving body is provided rotationally fixed on the shaft (1), which has sample recesses for laboratory samples arranged distributed circumferentially.

16. The drive arrangement according to claim 1, wherein a vertical measured distance (24) from a center of gravity (25) of the mass body (7) to an effective center plane (23) of the bearing (10) associated with the first bearing module (5) is less than one thirtieth of the effective bearing diameter (31) of the bearing (10) associated with the first bearing module (5).

17. The drive arrangement according to claim 1, wherein the center of gravity (25) of the mass body (7) is in the effective center plane (23) of the bearing (10) associated with the first bearing module (5).

18. The drive arrangement according to claim 1, wherein a weight of the mass body (7) corresponds to at least 20% of the weight of the rotating components of the rotational body device.
